(19) United States
(12) Patent Application Publication
(10) Pub. No.: US 2006/0059525 A1
(43) Pub. Date: Mar. 16, 2006

(54) Media services window configuration system

(76) Inventors: Dean F. Jerding, Roswell, GA (US); Arturo A. Rodriguez, Norcross, GA (US); Robert O. Banker, Cumming, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/238,369

(22) Filed: Sep. 29, 2005

Related U.S. Application Data
(62) Division of application No. 09/693,115, filed on Oct. 20, 2000.
Application No. 09/693,115 is a continuation-in-part of application No. 09/590,488, filed on Jun. 9, 2000.
(60) Provisional application No. 60/170,302, filed on Dec. 13, 1999.

(51) Int. Cl. H04N 7/173; H04N 5/445; H04N 7/16

(52) U.S. Cl. 725/87; 725/142; 725/45

(57) ABSTRACT

The invention may be viewed as a method for providing a user with information received by an interactive media services client device from a programmable media services server device. The method includes storing visual setting data in memory so that a plurality of applications can use the visual setting data to determine the appearance of items presented to the user.

### CROSS-REFERENCE TO RELATED APPLICATIONS

This application is a continuation-in-part of Application No. 9/590,488, filed on Jun. 9, 2000, and claims the benefit of U.S. Provisional Application No. 60/170,302, filed on Dec. 13, 1999, both of which are entirely incorporated herein by reference.

### FIELD OF THE INVENTION

This invention relates in general to television systems, and more particularly, to the fields of media-on-demand and interactive media guides.

### BACKGROUND OF THE INVENTION

With the recent advances in digital transmission technology, cable television systems are now capable of providing much more than the traditional analog broadcast video. In implementing enhanced programming, the home communication terminal (“HCT”), otherwise known as the settop box, has become an important computing device for accessing video services and navigating a subscriber through a maze of available services. In addition to supporting traditional analog broadcast video functionality, digital HCTs (or “DHCTs”) now also support an increasing number of two-way digital services such as video-on-demand.

Typically, a DHCT is connected to a cable or satellite television network and includes hardware and software necessary to provide the functionality of the digital television system at the client's site. Preferably, some of the software executed by a DHCT is downloaded and/or updated via the cable television network. Each DHCT also typically includes a processor, communication components and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

DHCTs today are capable of providing users with several services including video-on-demand and interactive media guides. Applications running on a DHCT are often created by separate companies, and thus, a graphical user interface (GUI) presented by one application may be significantly different from one presented by another application. As a result users may feel uncomfortable using certain services available via a DHCT and may even become confused as to the meanings associated with different colors and/or shapes. Therefore, there exists a need to make using a DHCT less intimidating and confusing.

### SUMMARY OF THE INVENTION

The invention may be viewed as a method for providing a user with information received by an interactive media services client device from a programmable media services server device. The method includes storing visual setting data in memory so that a plurality of applications can use the visual setting data to determine the appearance of items presented to the user.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram of a cable television system in accordance with one preferred embodiment of the present invention.

FIG. 2 is a diagram of the headend 11 as depicted in FIG. 1.

FIG. 3 is a block diagram of a DHCT and related equipment, in accordance with one preferred embodiment of the present invention depicted in FIG. 1.

FIG. 4 is a remote control device that can be used to provide user input to the DHCT shown in FIG. 3.

FIG. 5 depicts an example video-on-demand (VOD) rental selection screen that illustrates a media rental list presented to the user by the DHCT of FIG. 3.

FIG. 6 depicts an example browse-by window that is presented to a user after the user activates a certain button on the remote control device depicted in FIG. 4 while being presented with the rental selection window depicted in FIG. 5.

FIG. 7 depicts an example video-on-demand (VOD) rental selection screen that illustrates a category selected from the browse-by menu depicted in FIG. 6.

FIG. 8 depicts an example interactive media guide window that is presented to a user by the DHCT depicted in FIG. 3.

FIG. 9 depicts an example stopped video window that is presented to the user after the user stops the presentation of the video rental that was requested via the rental selection window depicted in FIG. 5.

FIG. 10 depicts example information barker that is presented to the user after the user requests a VOD rental via the rental selection window depicted in FIG. 5, if VOD service is temporarily unavailable.

FIG. 11 depicts example information barker is presented to a user at the end of a rental period for a movie selected via the rental selection window depicted in FIG. 5.

FIG. 12 depicts an example personal identification number (PIN) window that is presented to a user after the user selects a video title from the rental selection window depicted in FIG. 5.

FIG. 13 depicts an example personal identification number (PIN) window that is presented to a user after the user attempts to request a blocked media title via the rental selection window depicted in FIG. 5 or the interactive media guide depicted in FIG. 8.

FIG. 14 depicts an example foreground color selection window for configuring the foreground color of various areas and items in windows and barkers presented to a user by the DHCT depicted in FIG. 3.

FIG. 15 depicts an example background color selection window for configuring the background color of various areas and items in windows and barkers presented to a user by the DHCT depicted in FIG. 3.

FIG. 16 depicts an example color scheme selection window for configuring the colors of various areas and items in windows and barkers presented to a user by the DHCT depicted in FIG. 3.

FIG. 17 depicts an example font type selection window for configuring the font type for various items in windows and barkers presented to a user by the DHCT depicted in FIG. 3.

FIG. 18 depicts an example font size selection window for configuring the font size for various items in windows and barkers presented to a user by the DHCT depicted in FIG. 3.

FIG. 19 depicts an example font style selection window for configuring the font style for various items in windows and barkers presented to a user by the DHCT depicted in FIG. 3.

FIG. 20 depicts an example edge type configuration window for configuring the edge type for windows and barkers presented to a user by the DHCT depicted in FIG. 3.

FIG. 21 depicts an example edge thickness configuration window for configuring the edge thickness for windows and barkers presented to a user by the DHCT depicted in FIG. 3.

FIG. 22 depicts an example edge color configuration window for configuring the edge color for windows and barkers presented to a user by the DHCT depicted in FIG. 3.

FIG. 23 depicts an example edge continuity configuration window for configuring the edge continuity for windows and barkers presented to a user by the DHCT depicted in FIG. 3.

FIG. 24 depicts an example transition animation configuration window for configuring the animation effects used to introduce windows and barkers presented to a user by the DHCT depicted in FIG. 3.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

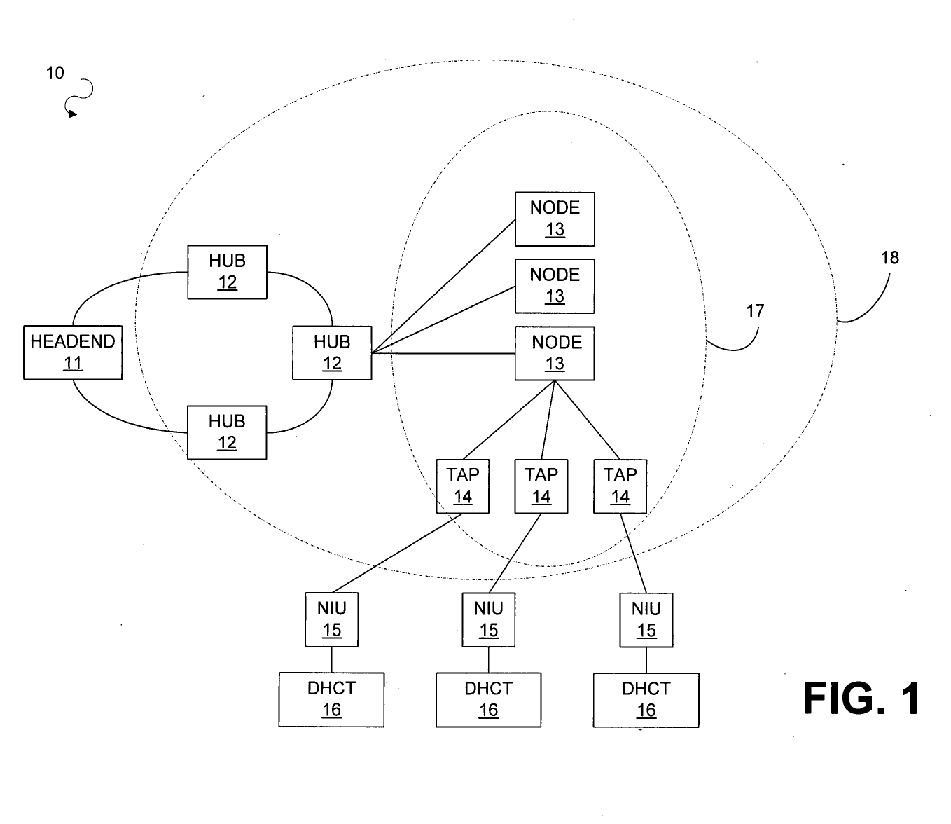

The present invention is generally implemented as part of a cable television system (CTS). Hence, an illustrative CTS 10 and its operation will be described initially. FIG. 1 shows a block diagram view of a CTS 10, which is generally a high quality, reliable and integrated network system that features video, audio, voice and data services to DHCT users. Although FIG. 1 depicts a high level view of a CTS 10, it should be appreciated that a plurality of cable television systems can tie together a plurality of regional networks into an integrated global network so that DHCT users can receive content provided from anywhere in the world.

The CTS 10 delivers broadcast video signals as digitally formatted signals in addition to delivering traditional broadcast analog video signals. Furthermore, the system can support one way broadcast services as well as both one-way data services and two-way media and data services. The two-way operation of the network allows for user interactivity with services, such as Pay-Per-View programming, Near Video-On-Demand (NVOD) programming according to any of several known NVOD implementation methods, View-on-Demand (VOD) programming (according to any of several known VOD implementation methods), and interactive applications, such as Internet connections and interactive media Guide (IMG) applications.

The CTS 10 also provides the interfaces, network control, transport control, session control, and servers to access content and services, and distributes content and services to DHCT users. As shown in FIG. 1, a typical CTS 10 comprises a headend 1 1, hubs 12, an HFC access network 17, and users' digital home communication terminals (DHCTs) 16. It should be appreciated that although a single component (e.g. a headend) is illustrated in FIG. 1, a CTS 10 can feature a plurality of any one of the illustrated components or may be configured with alternative embodiments for any one of the individual components or with yet other additional components not enumerated above. A content provider (not shown) transmits media content to a headend for further transmission to users downstream in the network.

Content provided by a content provider is communicated by the content provider to one or more headends 11. From those headends the content is then communicated over a communications network 18 that includes a plurality of HFC access networks 17 (only one HFC access network 17 is illustrated). The HFC access network 17 typically comprises a plurality of HFC nodes 13, each of which may serve a local geographical area. The hub 12 connects to the HFC node 13 through a fiber portion of the HFC access network 17. The HFC node 13 is connected to a tap 14 which is connected to a network interface unit (NW) 15 which is connected to a DHCT 16. The NIU 15 is normally located at a user's property and provides a transparent interface between the HFC node 13 and the users' internal wiring. Coaxial cables are typically used to couple nodes 13, taps 14 and NIUs 15 because the electrical signals can be easily repeated with radio frequency (RF) amplifiers.

As the high-level operations of many of the functions of CTSs 10 are well known to those of skill in the art, further description of the overall CTS 10 of FIG. 1 will not be contained herein. It will be appreciated, however, that the CTS 10 shown in FIG. 1 is merely illustrative and should not be construed as implying any limitations upon the scope of the present invention.

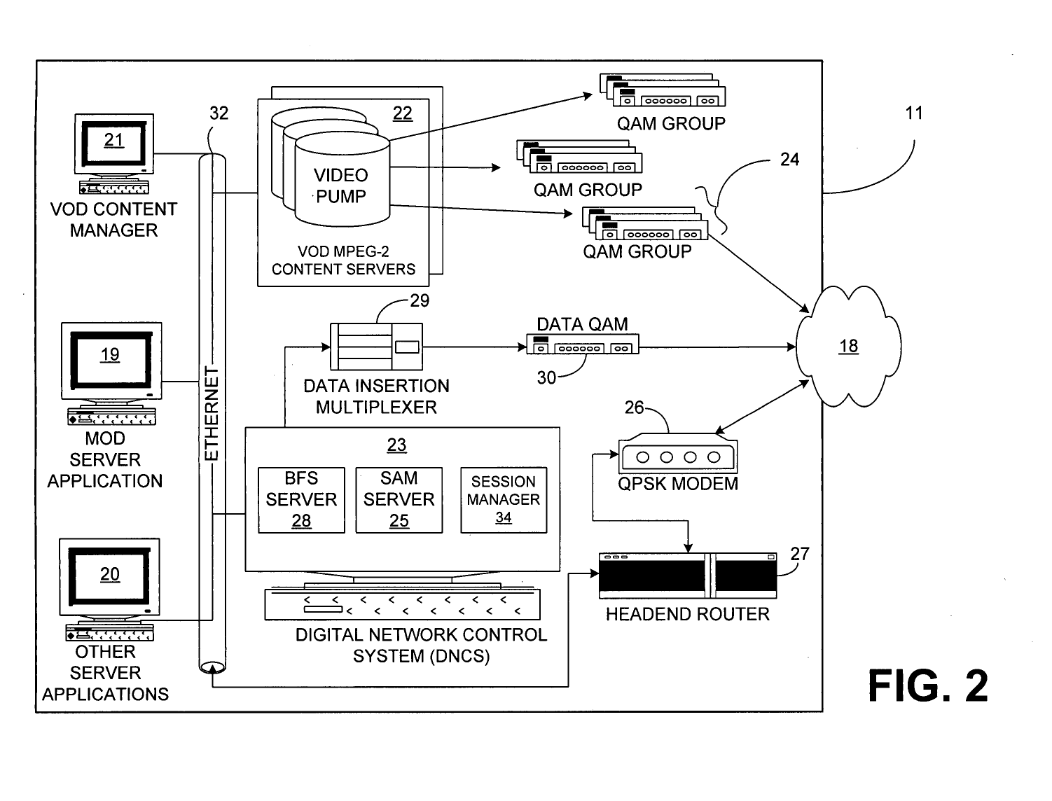

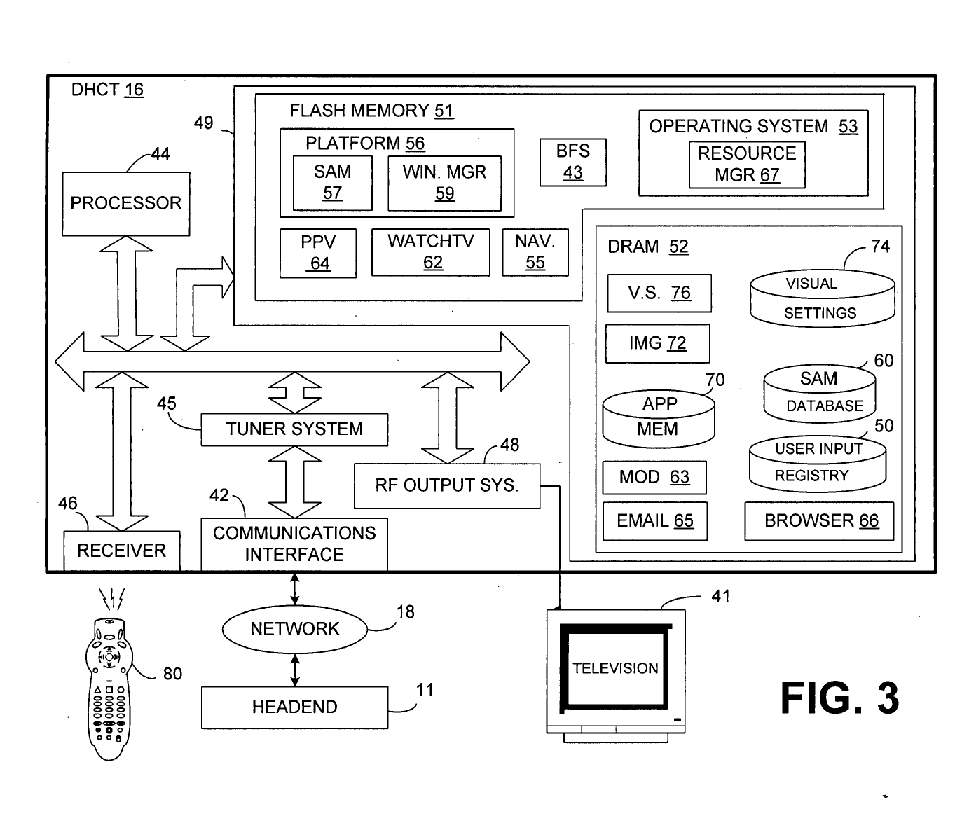

FIG. 2 is a block diagram of portions of a headend 11 that is configured to provide media-on-demand (MOD) services in accordance with one embodiment of the present invention. MOD services include, among other things, video-on-demand (VOD) services and respective MOD information suitable to be presented to a user via display of an interactive media guide. MOD server application 19 and a plurality of other server applications 20 are connected to a digital network control system (DNCS) 23 via a high-speed network such as an Ethernet connection 32. The MOD server application 19 is responsible for reserving and configuring system resources needed to provide MOD services and for providing configuration and service data to an MOD client application 63 (FIG.3), including MOD information comprising a catalog of titles available for on-demand viewing and/or on-demand rental by a user.

The DNCS 23 provides complete management, monitoring, and control of the network's elements and broadcast services provided to users. In one implementation, the DNCS 23 uses a data insertion multiplexer 29 and a data QAM 30 to insert in-band broadcast file system (BFS) data into an MPEG-2 transport stream that is broadcast and received via DHCT's communication interface 42 and tuner system 45. The DNCS 23 also contains a session manager 34 that uses Digital Storage Media Command and Control (DSMCC) protocol to set up and maintain MOD sessions. The session manager 34 processes user to network (U-N) session signaling messages, manages allocation of session-related network resources, supports network management operations, acts as a point of contact to the network for the DHCT's 16 in the network 18 to establish individual sessions, and supports MOD services by providing the signaling interface to establish, maintain and release client initiated exclusive sessions.

A service application manager (SAM) server 25 is a server component of a client-server pair of components, with the client component being located at the DHCT 16. Together, the client-server SAM components provide a system in which the user can access services, which are identified by an application to run and a parameter, such as particular data content, specific to that service. The client-server SAM components also manage the life cycle of the applications on the system, including the definition, activation, and suspension of services they provide and the downloading of the applications into the DHCT 16 as necessary.

Applications on both the headend 11 and the DHCT 16 can access the data stored in a broadcast file system (BFS) server 28 in a similar manner to a file system found on operating systems. The BFS server 28 is a part of a broadcast file system that has a counterpart BFS client module 43 (FIG. 3) in a DHCT 16 connected to the network 18. The BFS server 28 repeatedly sends data for applications on a data carousel (not shown) over a period of time in cyclical repeated fashion so that a DHCT 16 that is in need of reading any particular data file or parts thereof may receive it when requested by a user or one or more of its internal running processes.

A VOD content manager 21 is responsible for managing the content on the VOD content servers 22. The MOD server application 19 controls both the VOD content manager 21 and the VOD content servers 22 and utilizes them to help deliver the video and audio streams that make up VOD services. In one embodiment, an MOD content manager and MOD content servers (not shown) could run respectively in parallel to the VOD content manager 21 and VOD content servers 22 to manage other types of on-demand media content. In an alternate embodiment an MOD content manager replaces the VOD content manager 21 and the MOD content servers replaces the VOD content servers 22. The QAM modulators that comprise the QAM group 24 receive the MPEG-2 transport streams from the VOD content servers 22, convert them into encrypted RF signals at a specified frequency (channel), and transmit them to a DHCT 16 via the network 18.

The QPSK modem 26 is responsible for transporting the out-of-band IP (internet protocol) datagram traffic between the distribution headend 11 and a DHCT 16. Data from the QPSK modem 26 is routed by headend router 27 within the headend 11. The headend router 27 is also responsible for delivering upstream application traffic to the various server applications 19 & 20.

FIG. 3 is a block diagram illustrating a DHCT 16 that is coupled to a headend 11 and to a television 41. Some of the functionality performed by applications executed in the DHCT 16 (such as the MOD client application 63) may instead be performed at the headend 11 and vice versa. A DHCT 16 is typically situated at a user's residence or place of business and may be a stand alone unit or integrated into another device such as, for example, a television set or a personal computer. The DHCT 16 preferably includes a communications interface 42 for receiving signals (video, audio and/or other data) from the headend 11 through the network 18 and for providing any reverse information to the headend 11 through the network 18. The DHCT 16 further includes at least one processor 44 for controlling operations of the DHCT 16, an RF output system 48 for driving the television display 41, and a tuner system 45 for tuning into a particular television channel to be displayed and for sending and receiving various types of data or media from the headend 11. The tuner system 45 includes, in one implementation, an out-of-band tuner for bi-directional quadrature phase shift keying (QPSK) data communication and a quadrature amplitude modulation (QAM) tuner for receiving television signals. Additionally, a receiver 46 receives externally-generated information, such as user inputs or commands from other devices.

The DHCT 16 may also include one or more wireless or wired interfaces, also called ports, for receiving and/or transmitting data to other devices. For instance, the DHCT 16 may feature USB (Universal Serial Bus), Ethernet (for connection to a computer), IEEE-1394 (for connection to media devices in an entertainment center), serial, and/or parallel ports. The user inputs may, for example, be provided by a computer or transmitter with buttons or keys located either on the exterior of the terminal or by a hand-held remote control device or keyboard that includes user-actuated buttons.

In one implementation, the DHCT 16 includes system memory 49, which includes flash memory 51 and dynamic random access memory (DRAM) 52, for storing various applications, modules and data for execution and use by the processor 44. Basic functionality of the DHCT 16 is provided by an operating system 53 that is primarily stored in flash memory 51. Among other things, the operating system 53 includes at least one resource manager 67 that provides an interface to resources of the DHCT 16 such as, for example, computing resources.

One or more programmed software applications, herein referred to as applications, are executed by utilizing the computing resources in the DHCT 16. Applications stored in flash memory 51 or DRAM 52 are executed by processor 44 (e.g., a central processing unit or digital signal processor) under the auspices of the operating system 53. Data required as input by an application is stored in DRAM 52 or flash memory 51 and read by processor 44 as need be during the course of the application's execution. Input data may be data stored in DRAM 52 by a secondary application or other source, either internal or external to the DHCT 16, or possibly anticipated by the application and thus created with the application at the time it was generated as a software application, in which case it is stored in flash memory 51. Data generated by an application is stored in DRAM 52 by processor 44 during the course of the application's execution. DRAM 52 also includes application memory 70 that various applications may use for storing and/or retrieving data.

An application referred to as navigator 55 is also resident in flash memory 51 for providing a navigation framework for services provided by the DHCT 16. The navigator 55 registers for and in some cases reserves certain user inputs related to navigational keys such as channel increment/decrement, last channel, favorite channel, etc. The client applications may be resident in flash memory 51 or downloaded into DRAM 52. The navigator 55 also provides users with television related menu options that correspond to DHCT functions such as, for example, providing an interactive program guide, blocking a channel or a group of channels from being displayed in a channel menu, and displaying a video-on-demand purchase list.

The flash memory 51 also contains a platform library 56. The platform library 56 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 56 that are shown in FIG. 3 are a window manager 59 and a service application manager client (SAM) 57.

The window manager 59 provides a mechanism for implementing the sharing of the screen regions and user input. The window manager 59 on the DHCT 16 is responsible for, as directed by one or more applications, implementing the creation, display, and de-allocation of the limited DHCT 16 screen resources. It allows multiple applications to share the screen by assigning ownership of screen regions, or windows. The window manager 59 also maintains, among other things, a user input registry 50 in DRAM 52 so that when a user enters a key or a command via the remote control device 80 or another input device such as a keyboard or mouse, the user input registry 50 is accessed to determine which of various applications running on the DHCT 16 should receive data corresponding to the input key and in which order. As an application is executed, it registers a request to receive certain user input keys or commands. When the user presses a key corresponding to one of the commands on the remote control device 80, the command is received by the receiver 46 and relayed to the processor 44. The processor 44 dispatches the event to the operating system 53 where it is forwarded to the window manager 59 which ultimately accesses the user input registry 50 and routes data corresponding to the incoming command to the appropriate application.

The SAM client 57 is a client component of a client-server pair of components, with the server component being located on the headend 11. A SAM database 60 in DRAM 52 includes a data structure of services and a data structure of channels that are created and updated by the headend 11. Many services can be defined using the same application component, with different parameters. Examples of services include, without limitation and in accordance with one implementation, presenting television programs (available through a WatchTV application 62), pay-per-view events (available through a PPV application 64), digital music (not shown), media-on-demand (available through an MOD application 63), and an interactive program guide. In general, the identification of a service includes the identification of an executable application that provides the service along with a set of application-dependent parameters that indicate to the application the service to be provided. As a non-limiting example, a service of presenting a television program could be executed with a set of parameters to view HBO or with a separate set of parameters to view CNN. Each association of the application component (tune video) and one parameter component (HBO or CNN) represents a particular service that has a unique service I.D. The SAM client 57 also interfaces with the resource manager 67, as discussed below, to control resources of the DHCT 16.

Application clients can also be downloaded into DRAM 52 at the request of the SAM client 57, typically in response to a request by the user or in response to a message from the headend. In this non-limiting example DRAM 52 contains a media-on-demand application (MOD) 63, an e-mail application 65, and a web browser application 66, among others (not shown). It should be clear to one with ordinary skill in the art that these applications are not limiting and merely serve as examples for this present embodiment of the invention. Furthermore, one or more DRAM based applications may, as an alternative embodiment, be resident in flash memory 51. These applications, and others provided by the cable system operator, are top level software entities on the network for providing services to the user.

In one implementation, applications executing on the DHCT 16 work with the navigator 55 by abiding by several guidelines. First, an application utilizes the SAM client 57 for the provision, activation, and suspension of services. Second, an application shares DHCT 16 resources with other applications and abides by the resource management policies of the SAM client 57, the operating system 53, and the DHCT 16. Third, an application handles situations where resources are only available with navigator 55 intervention. Fourth, when an application loses service authorization while providing a service, the application suspends the service via the SAM (the navigator 55 will reactivate an individual service application when it later becomes authorized). Finally, an application client is designed to not have access to certain user input keys reserved by the navigator (i.e., power, channel ±, volume ±, etc.).

The MOD client application 63 provides the user with lists of available media titles to choose from and with video presentations requested by the user. The MOD client application 63 provides video presentations to the user by engaging, preferably, in a direct two-way IP (Internet Protocol) connection with VOD content servers 22 (FIG. 2).

An executable program or algorithm corresponding to an operating system (OS) component, or to a client platform component, or to a client application, or to respective parts thereof, can reside in and execute out of DRAM 52 and/or flash memory 51. Likewise, data inputted into or outputted from any executable program can reside in DRAM 52 or flash memory 51. Furthermore, an executable program or algorithm corresponding to an OS component, or to a client platform component, or to a client application, or to respective parts thereof, can reside in flash memory 51, or in a local storage device connected to DHCT 16 and be transferred into DRAM 52 for execution. Likewise, data input for an executable program can reside in flash memory 51 or a storage device and be transferred into DRAM 52 for use by an executable program or algorithm. In addition, data outputted by an executable program can be written into DRAM 52 by an executable program or algorithm and be transferred into flash memory 51 or into a storage device for storage purposes. The present invention is not limited by where or how data and/or applications are stored or retrieved.

Each of the above mentioned applications comprises executable instructions for implementing logical functions and can be embodied in any computer-readable medium for use by or in connection with an instruction execution system, apparatus, or device, such as a computer-based system, processor-containing system, or other system that can fetch and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner, and then stored in a computer memory.

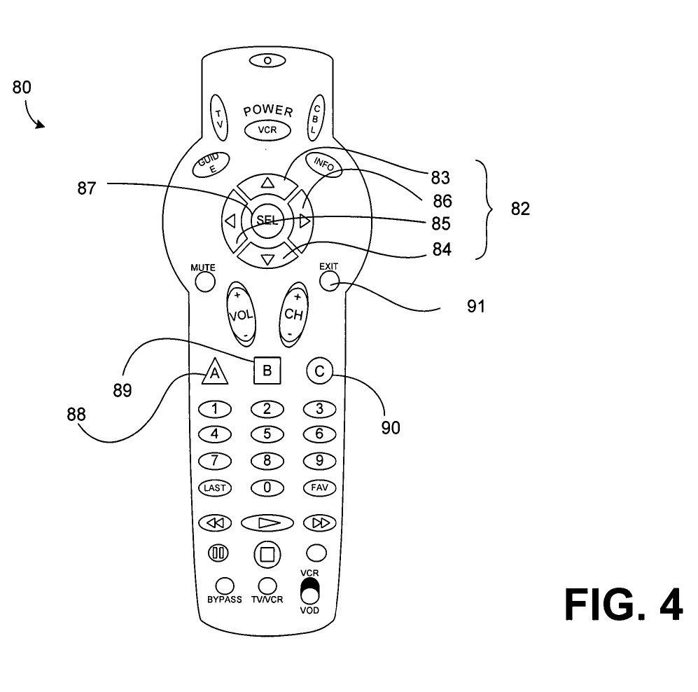

FIG. 4 illustrates a non limiting example of a remote control device 80 that is used to provide user input to the DHCT 16. The arrow buttons 82 include an up arrow button 83, a down arrow button 84, a left arrow button 85, and a right arrow button 86 that are used to scroll through options and/or to highlight an option. The select button 87 may be used to select a currently highlighted option that is provided to the user. Many alternative methods of providing user input may be used including a remote control device with different buttons and/or button layouts, a keyboard device, a voice activated device, etc. The invention described herein is not limited by the type of device used to provide user input.

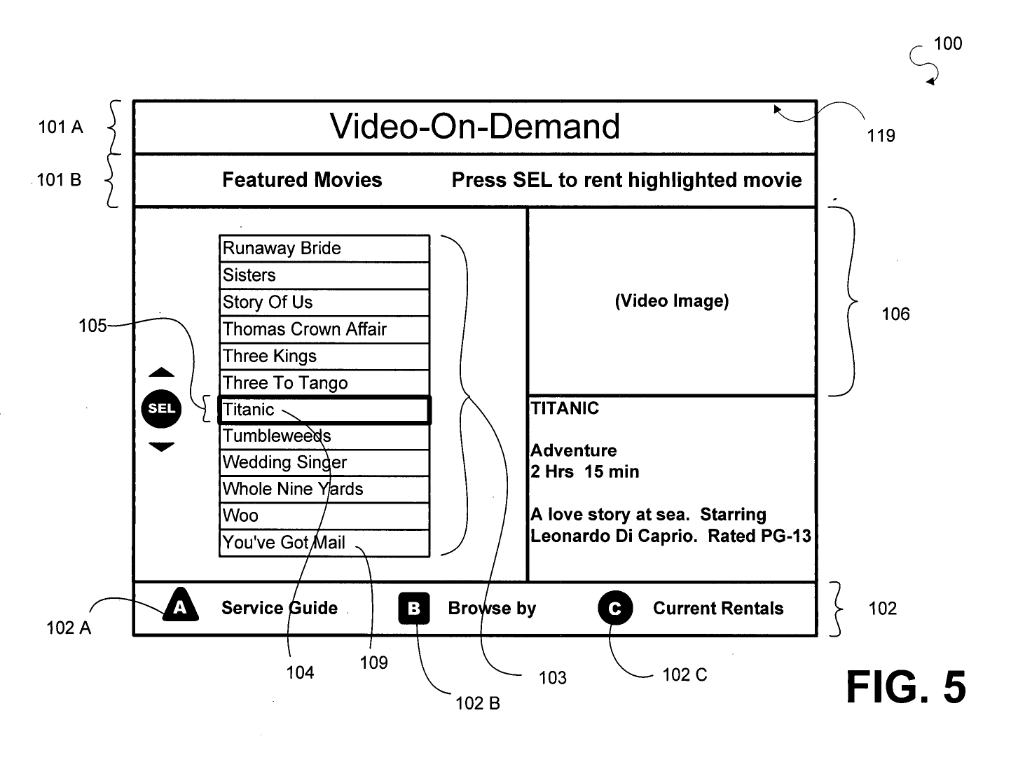

With continued reference to FIGS. 3 & 4 throughout the remaining figures, FIG. 5 shows an example VOD rental selection window 100. As with other window examples discussed below, processor 44 executes program instructions of MOD client application 63 that cause it to direct the window manager 59 to create window 100 via display data that is formatted for television 41. Processor 44 stores the display data or parts thereof in DRAM 52 (as necessary) and transfers the display data to a display output system such as RF output system 48 wherein display data is converted to respective television signals and transmitted to television 41. Of course, the scope of the invention also includes any other method of causing the described windows to appear to the user.

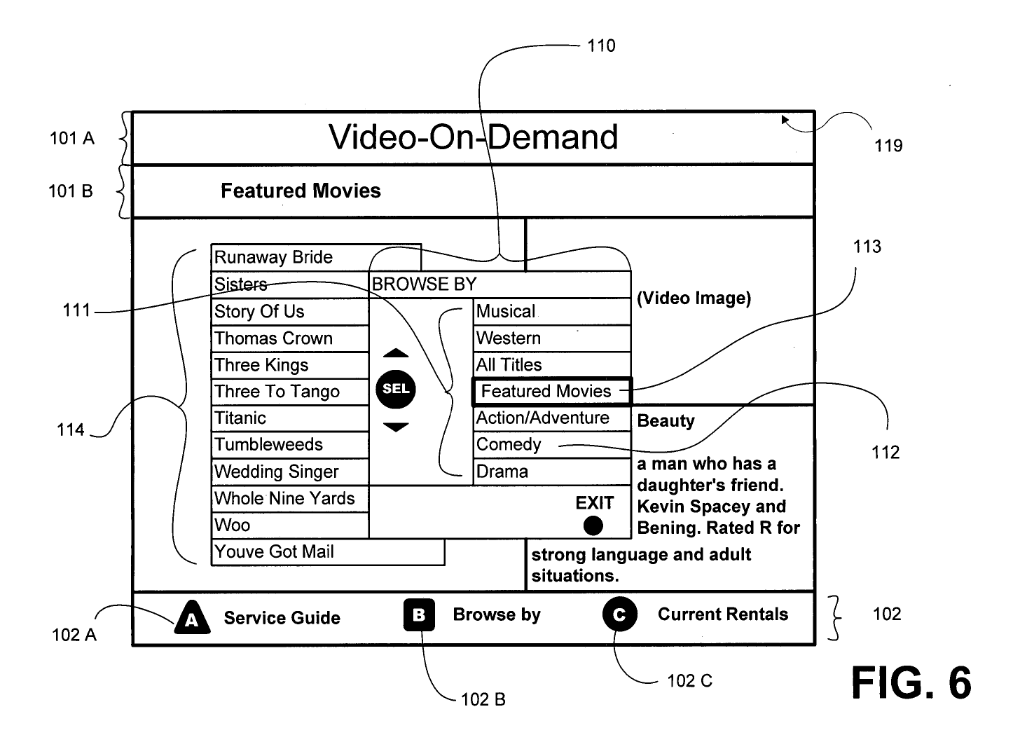

A user may utilize the rental selection window 100 in order to request a video-on-demand rental. First heading portion 101A and second heading portion 101B typically contain headings, while bottom portion 102 typically illustrates relevant navigation buttons available. In the current example window, first heading portion 101A contains the heading “Video-On-Demand”, second heading portion 101B contains the heading “Featured Movies” and the instruction “Press SEL to rent highlighted movie”, and bottom portion 102 indicates that a “B” button 89 that can be used to access a browse-by list (depicted in FIG. 6).

Video rental list 103 contains the titles of video presentations, such as video title 104, that are available for rent as well as a highlighted title area 105. A user may scroll through the video rental list using the up and down arrow buttons 83 & 84, and may request a currently highlighted video title by activating the select button 87. For example, a user may activate the down arrow until the selection “You've Got Mail” 109 is highlighted and then request to see the video titled “You've Got Mail” 109 by activating the select button 87. A reduced screen area 106 displays an image corresponding to the highlighted video title. As the user scrolls through the video rental list 103, the image displayed in the reduced screen area 106 changes accordingly.

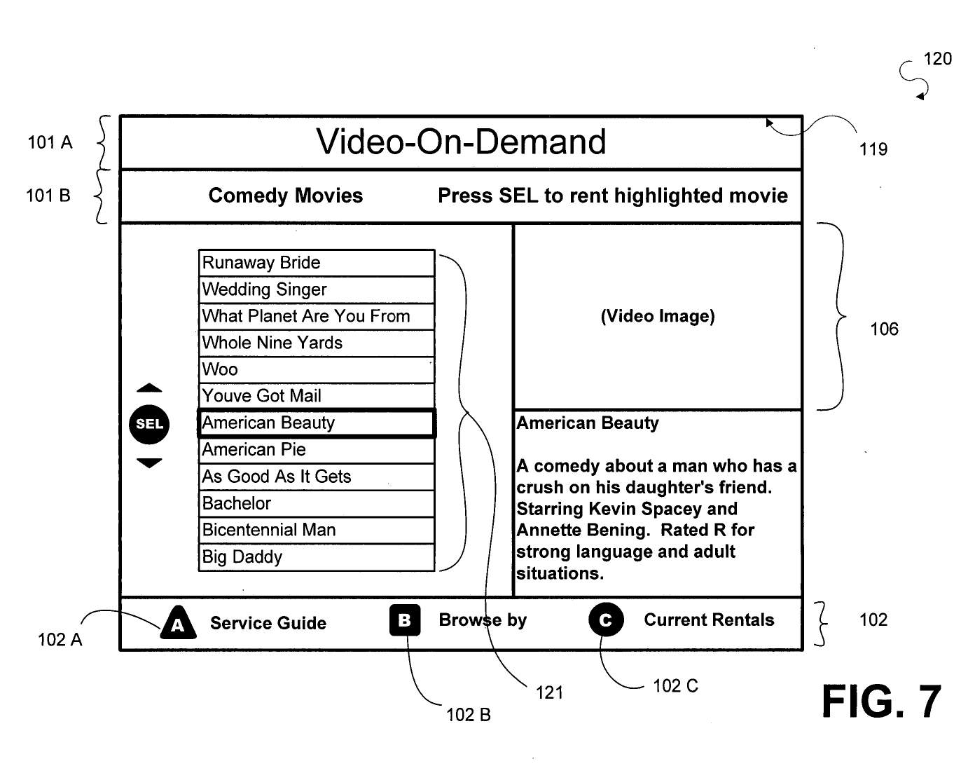

FIG. 6 depicts an example browse-by window 110 that is presented to a user after the user activates the “B” button 89 while being presented with rental selection window 100. A user may close the browse-by window 110 by activating the “Exit” button 91 or may scroll through the browse-by list 111 and select a browse-by option by using the remote control device 80 as described above. For example, the user may select the “Comedy” option 112 in order to access a list of comedy media titles as illustrated in example window 120 in FIG. 7. Example window 120 depicts a rental selection window containing a video rental list 121 that exclusively contains comedy media titles. A user may scroll through the video rental list 121 and select a video rental in a manner similar to the one described above in connection with FIG. 5.

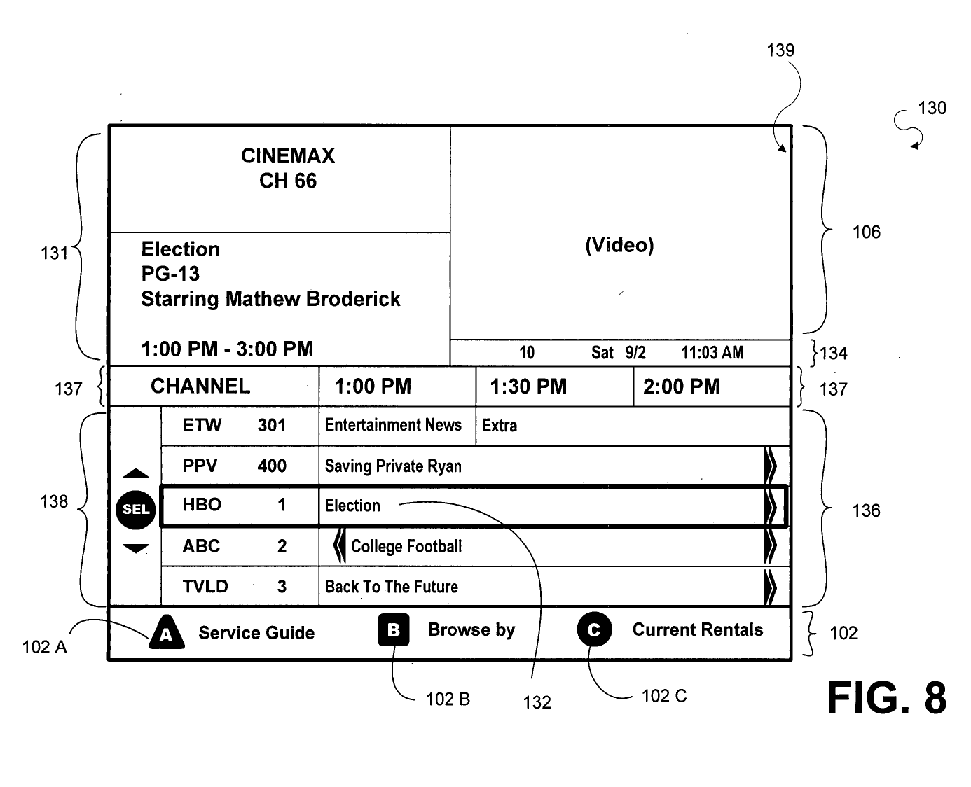

FIG. 8 depicts an example interactive media guide window 130 that illustrates an initial guide arrangement in a time format. Window 130 is presented to a user based on instructions contained in the IMG client application 72. Of course, the scope of the invention also includes any other method of causing the described windows to appear to the user. The top left portion of the example window 130 is a detailed focus area 131 that includes detailed channel information (channel number, channel name (HBO), media name, media description, duration, any episode information or rating, etc.) for an “in-focus” media corresponding to highlighted title area 132 in a main media title display area 136. The media presentation showing on the channel to which the DHCT 16 is currently tuned (for which audio is also playing, and which is typically the media occupying the full window before the IMG client application 72 is activated) is displayed in a reduced screen area 106 in example window 130. Immediately below the reduced screen area 106 is an information banner 134 showing the channel to which the DHCT 16 is currently tuned, the current day and date, and the current time. The middle left portion of example window 130 includes a channel area 138 that contains channel numbers and channel name abbreviations corresponding to media titles in the media title display area 136. Heading portion 137 contains headings related to the information displayed in the channel area 138 and the main media title display area 136. The main media title display area 136 contains media titles corresponding to media presentations that are or will be available for viewing during the time periods listed in the heading portion 137 and via the channels listed in the channel area 138.

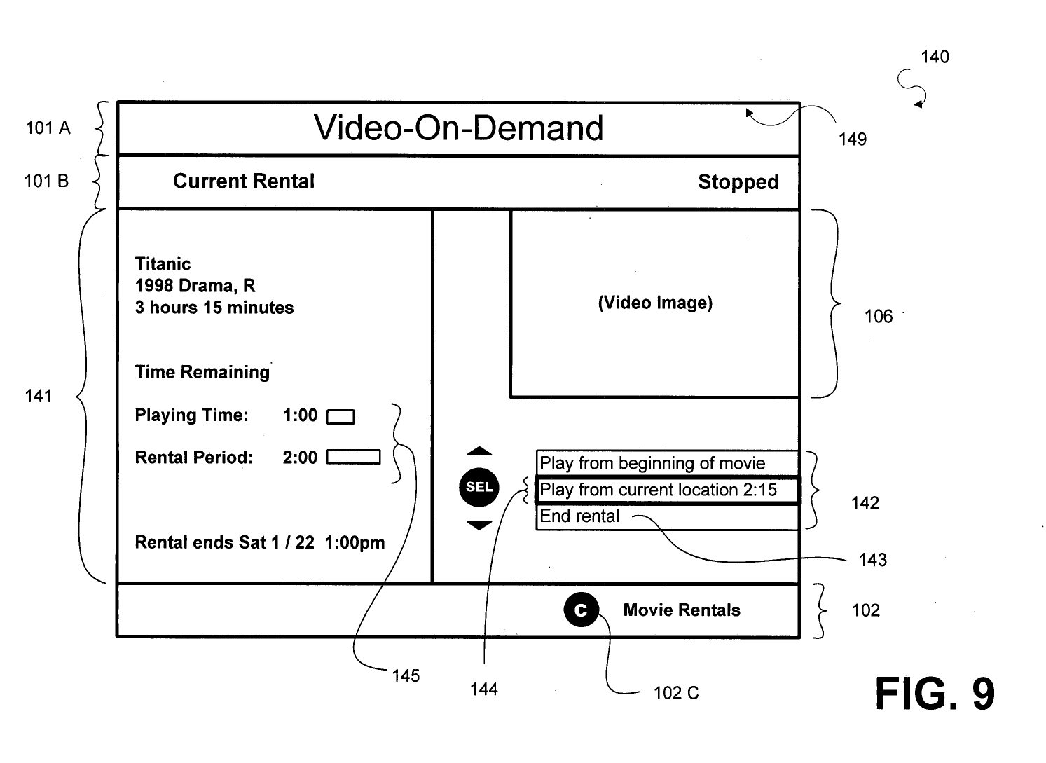

FIG. 9 depicts an example stopped video window 140 that is presented to the user after the user stops the presentation of the video rental that was requested via the VOD rental selection window 100 (FIG. 5). The reduced screen area 106 displays an image from the media rental that was being presented to the user prior to example window 140 being displayed. Information section 141 contains information related to the media rental associated with the image displayed in the reduced screen area 106, including numerical and graphical indications 145 as to the playing time and rental time remaining for the media rental. Rental control options list 142 contains rental control options, such as the option to “End rental” 143, and a highlighted option area 144. A user can select a rental control option by using the remote control device 80. For example, a user may activate the down arrow button 84 until the selection “End rental” 143 is highlighted, and then request to end the video rental by activating the select button 87 .

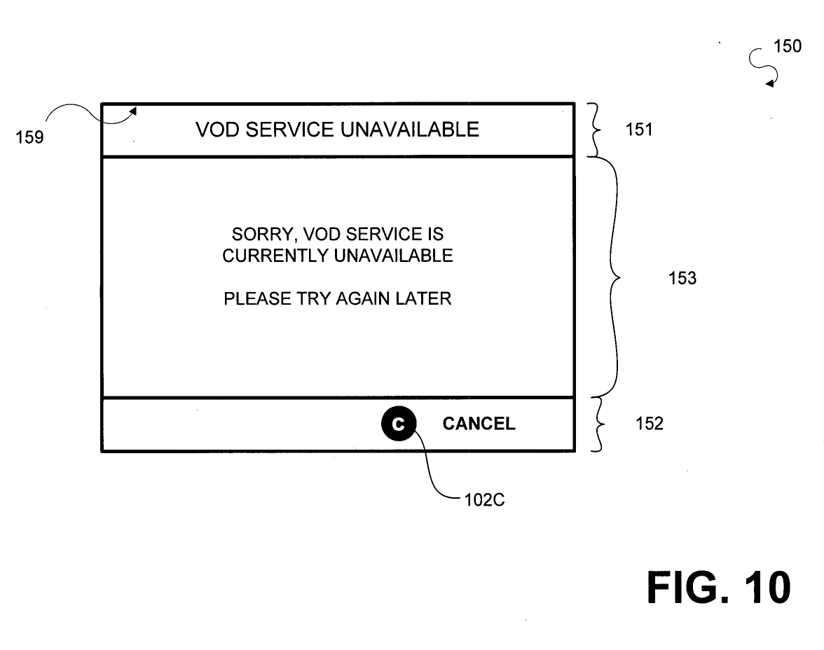

FIGS. 10 & 11 depict example information barkers 150 & 160. Information barker 150 is presented to the user after the user requests a VOD rental, if for some reason VOD service is temporarily unavailable. Top portion 151 contains a heading, bottom portion 152 illustrates relevant navigation button(s) available on the remote control device 80, and center portion 153 provides the user with a message. In Example barker 150 the message displayed in center portion 153 states “SORRY, VOD SERVICE IS CURRENTLY UNAVAILABLE. PLEASE TRY AGAIN LATER”. Example barker 160 is presented to a user at the end of a video-on-demand rental period for the movie Titanic and has a center portion 153 that states “THANK YOU FOR RENTING TITANIC”.

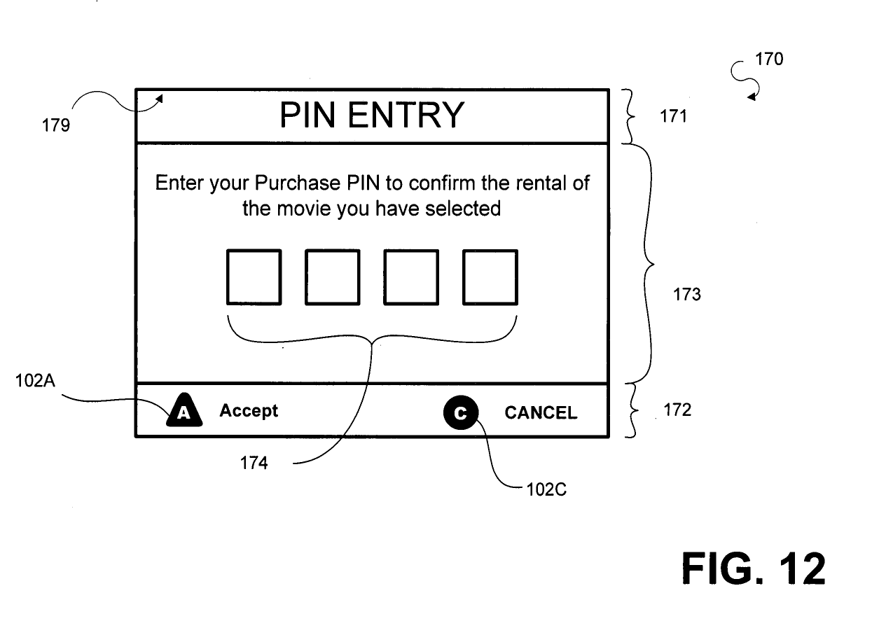

FIGS. 12 & 13 depict example personal identification number (PIN) windows 170 & 180. PIN entry window 170 is presented to the user after the user selects a video title from the rental selection window 100 whereas PIN entry window 180 is presented to a user after the user attempts to view or request a blocked media title. In both PIN windows 170 & 180, the top portion 171 contains the heading “PIN ENTRY” while the bottom portion 172 illustrates relevant navigation buttons available on the remote control device 80. In the current example, bottom portion 172 illustrates that the “A” button 88 (FIG. 4) may be used to confirm the entry of a PIN and that the “C” button 90 may be used to cancel the current video rental request. A user can enter his PIN using the remote control device 80 while being presented with a PIN entry window. Center portion 173 contains entry fields 174 that display a “*” for every PIN entry received from the user. In an alternative embodiment, the entry fields display the actual numbers entered by the user. In yet another alternative embodiment, a user is not presented with a PIN entry window and is not required to enter a PIN to receive a video rental.

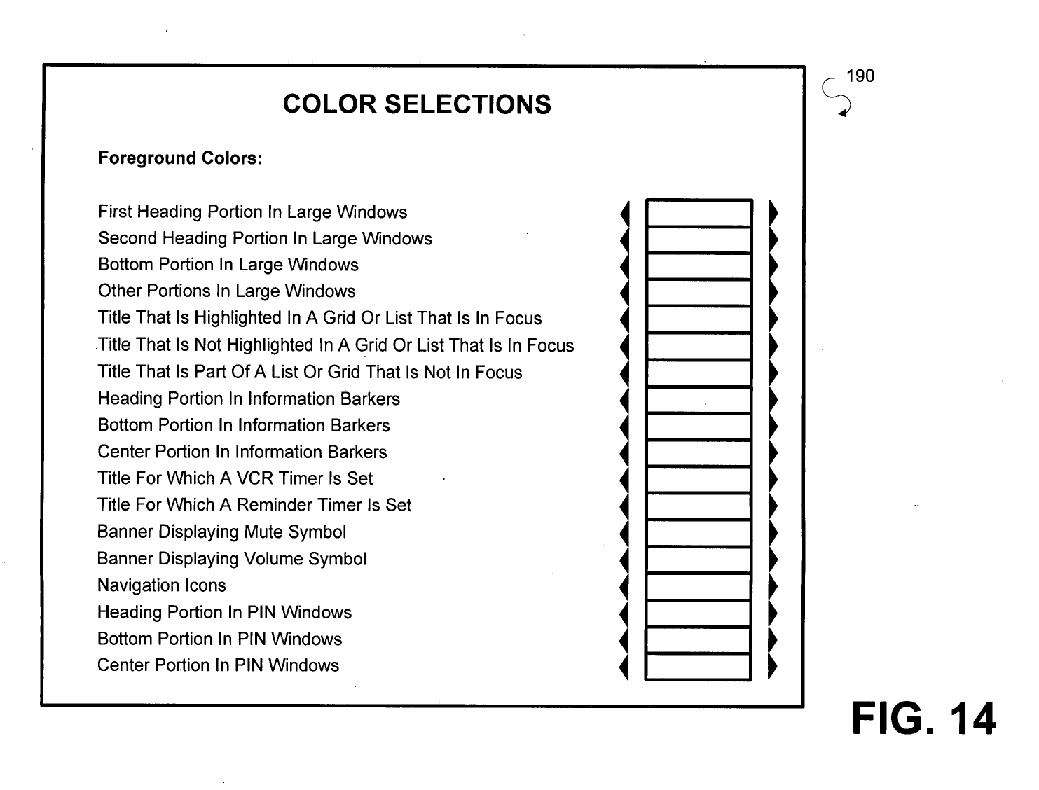

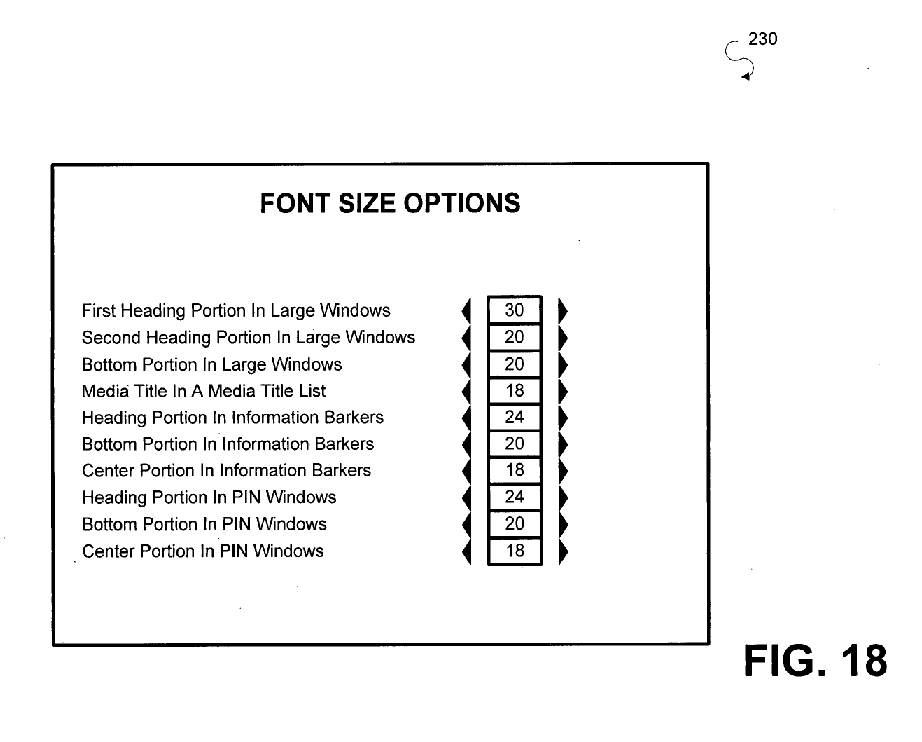

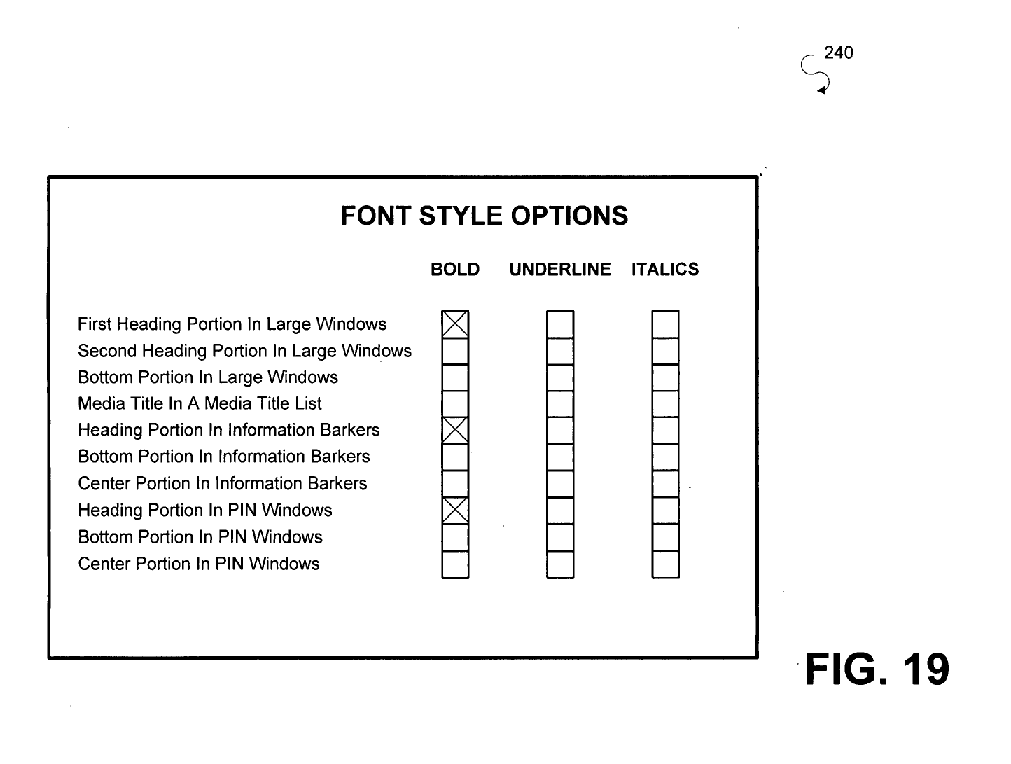

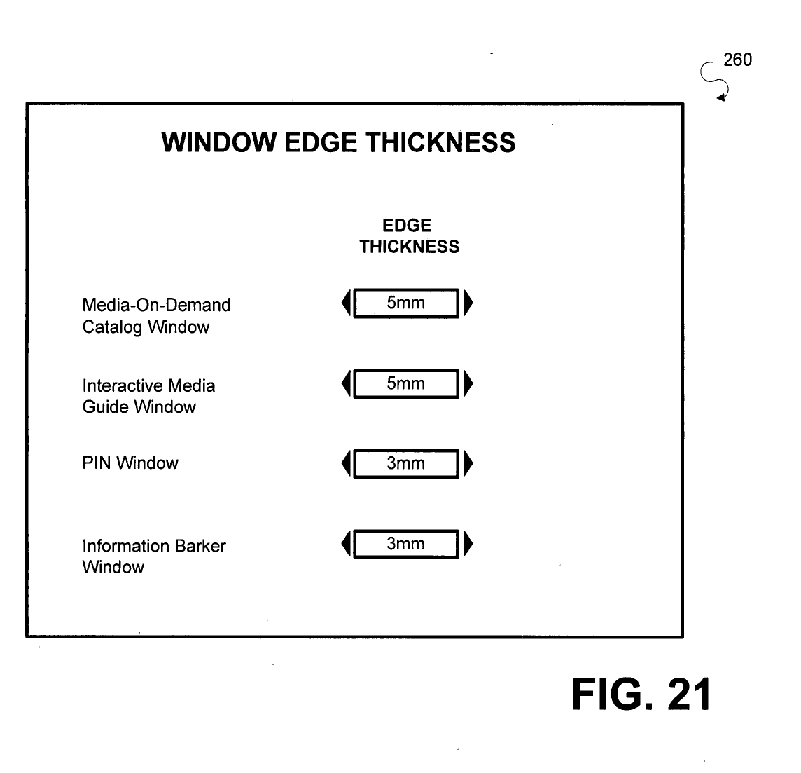

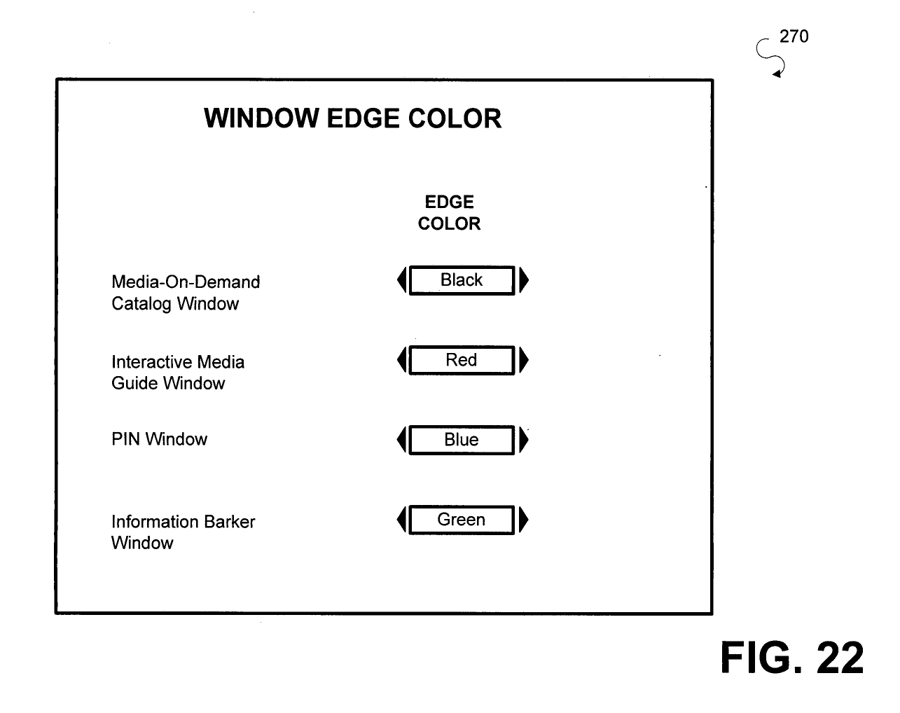

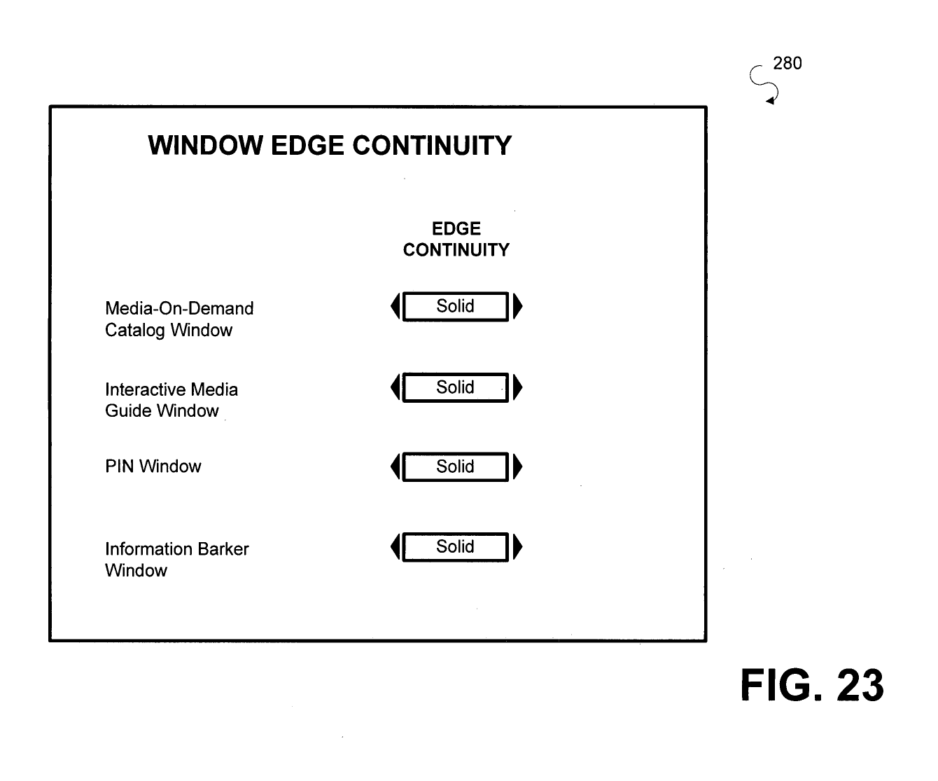

FIGS. 14-23 depict example visual settings windows that a user and/or a headend system operator, in accordance with various embodiments, may use to configure various areas and items in windows and barkers presented to a user by a DHCT application. In the case of user determined settings, a visual settings application 76 presents the user with a visual settings windows (in response to user input requesting the visual settings window) and is responsible for storing user input related to visual settings in a visual settings database 74.

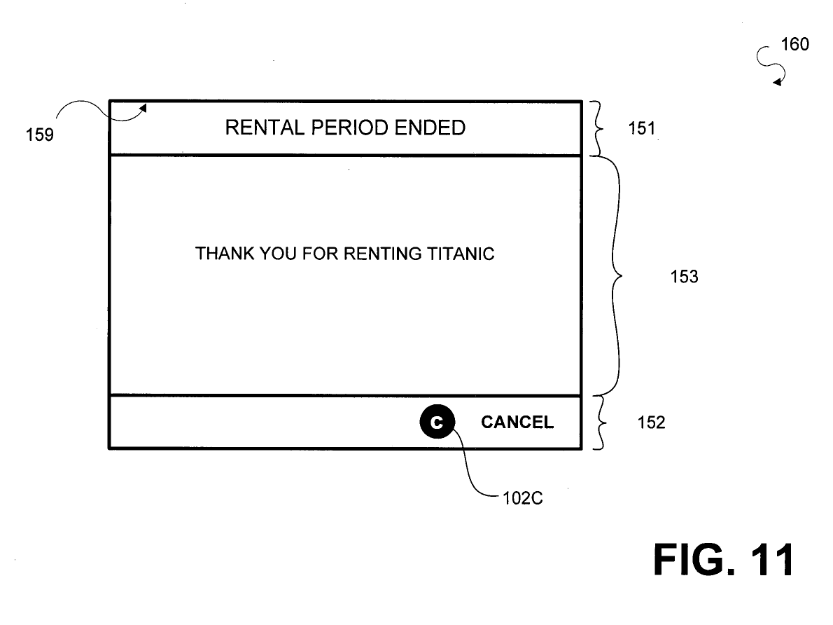

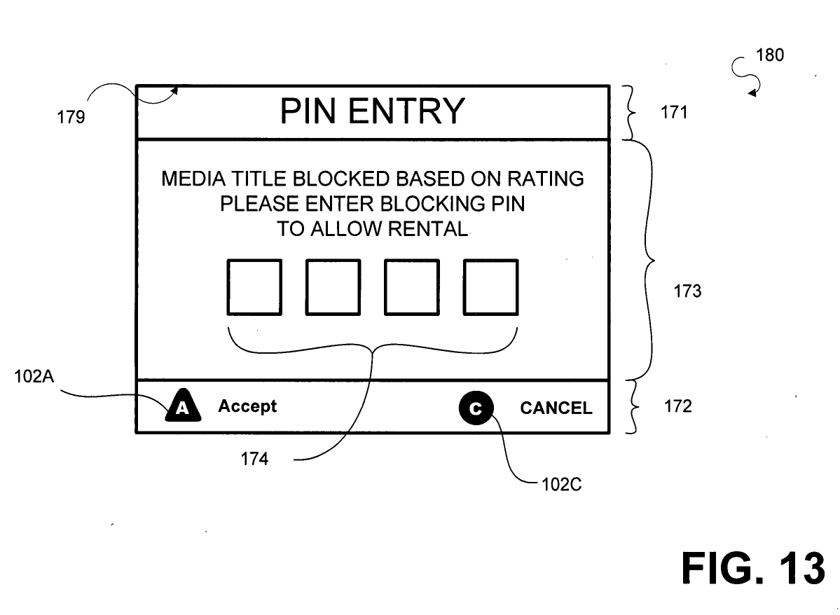

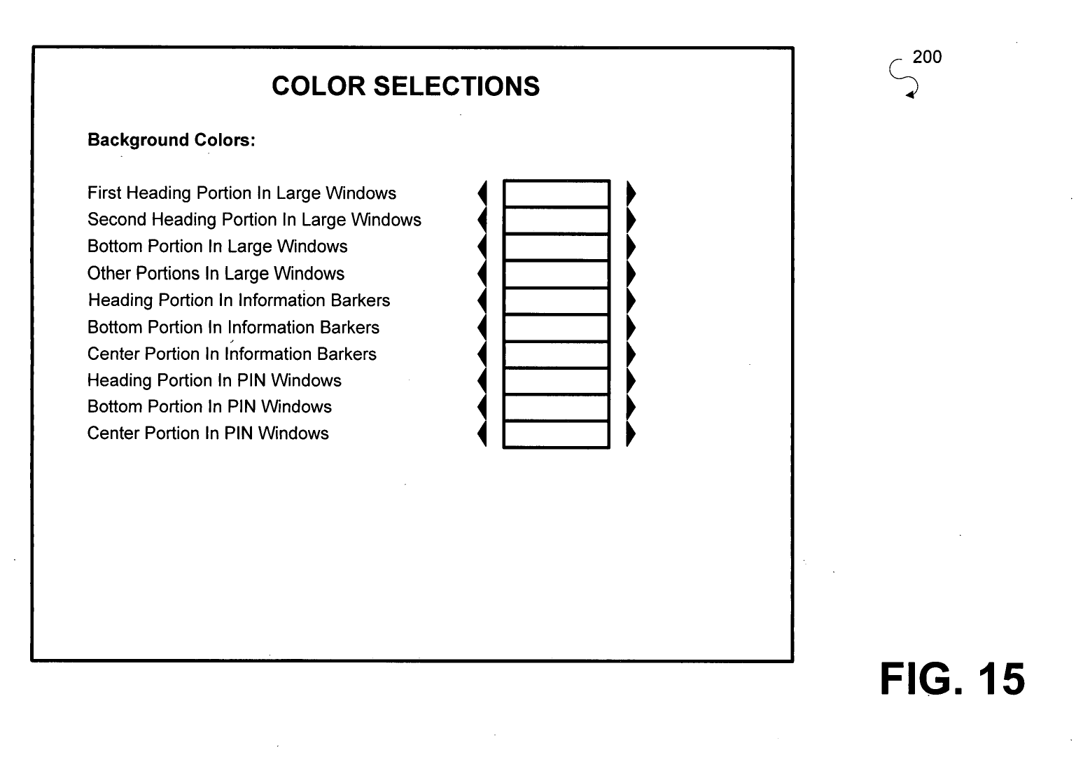

With reference to FIGS. 5-13, a user and/or system operator may make color information entries via windows 190 and 200 (FIGS. 14 and 15) for defining foreground and/or background colors for one or more of the following: a first heading portion 101A in a window, a second heading portion in a window 101B, a bottom portion in a window 102, a title that is highlighted 113 in a grid or list that is in focus 111, a title that is not highlighted 112 and that is in grid or list that is in focus 111, a title that is part of a list or grid that is not in focus 114, a heading portion 151 of an information barker, a bottom portion 152 of an information barker, a center portion 153 of an information barker, a title for which a VCR timer is set (not shown), a title for which a reminder timer is set (not shown), a banner for displaying a mute symbol (not shown), a banner for displaying a volume symbol (not shown), navigation icons 102A, 102B, and 102C, a heading portion 171 in a PIN entry window, a bottom portion 172 in a PIN entry window, a center portion 173 in a PIN entry window, and PIN entry fields 174 in a PIN entry window etc. The preceding list is non-exhaustive as there may be other items and/or areas in the above windows or in other windows for which a foreground or background color may be specified.

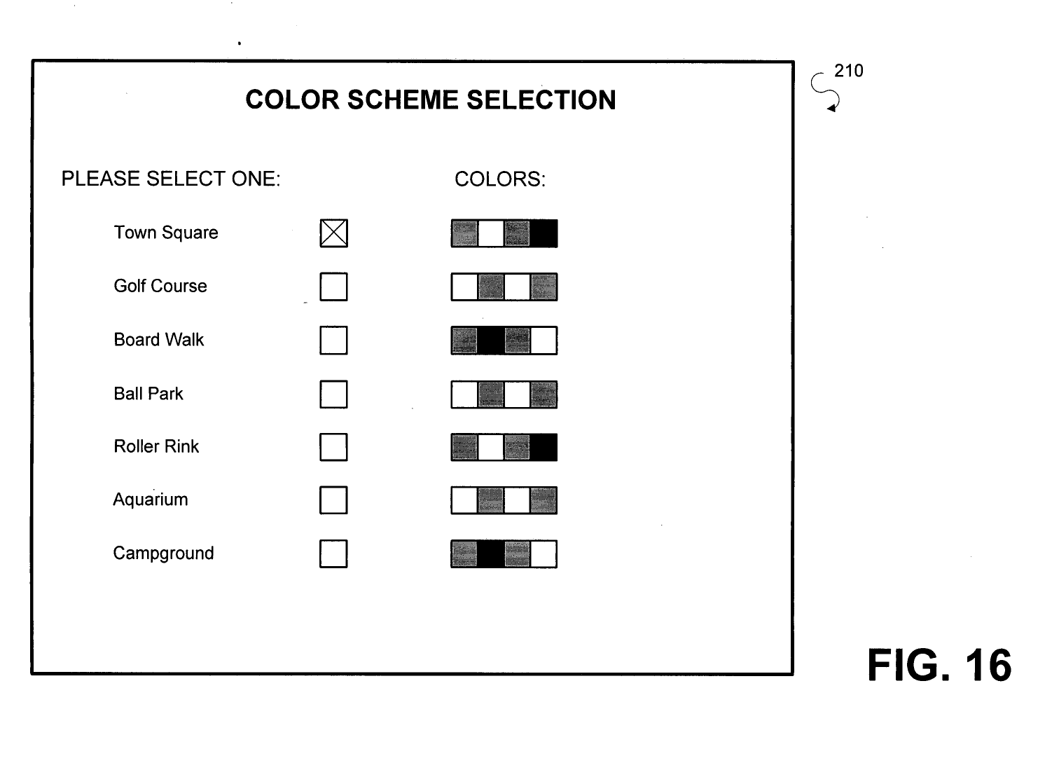

FIG. 16 depict an example color scheme selection window 210 that a user and/or headend system operator may use to supply color scheme information for determining the colors of various areas and items in windows and barkers presented to a user by a DHCT application. Each color scheme is assigned a pre-determined name and is associated with a pre-determined set of color selections. Respective color spectrums are displayed in the color scheme selection window 210 to help remind the user and/or system operator of the colors used in various color schemes.

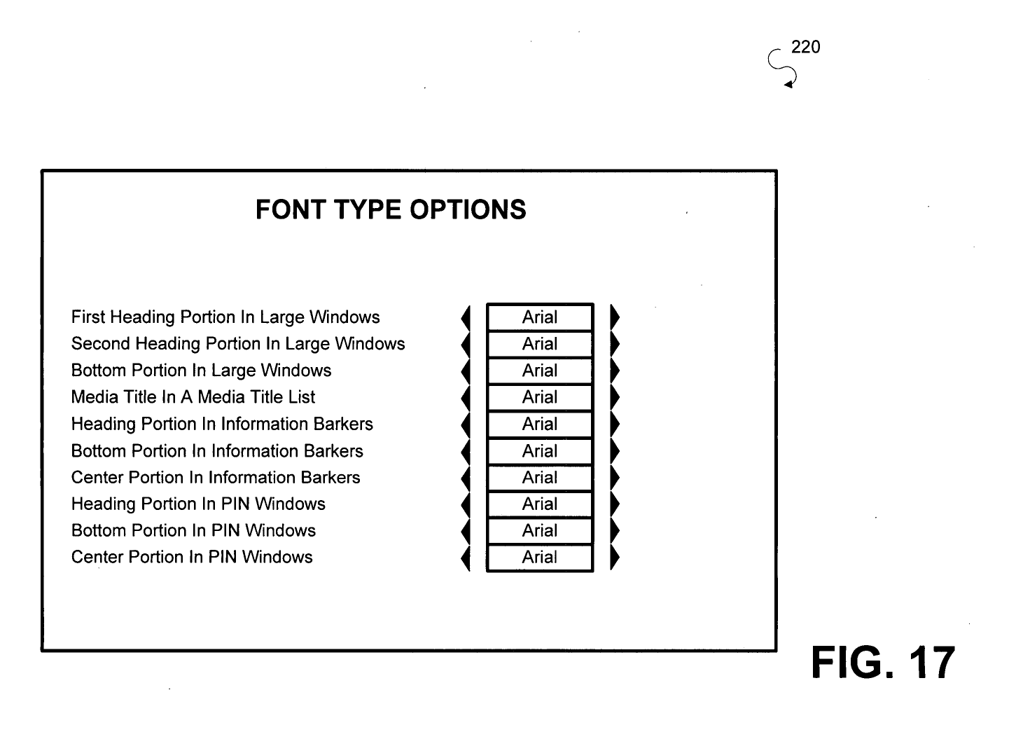

FIGS. 17, 18, and 19 depict example font type, size, and style configuration windows 220, 230, and 240 respectively that a user and/or system operator may use to determine the font type, size, and style of characters contained in various window portions. Font type configuration may include font types such as, for example, Times New Roman or Arial. Font style configuration may include settings such as, for example, italics, bold or underlining. In one embodiment, a user and/or system operator are also provided the ability to determine font outline configuration. Font outline configurations may include, for example, fonts with a black border that limits flicker effects produced by interlaced televisions.

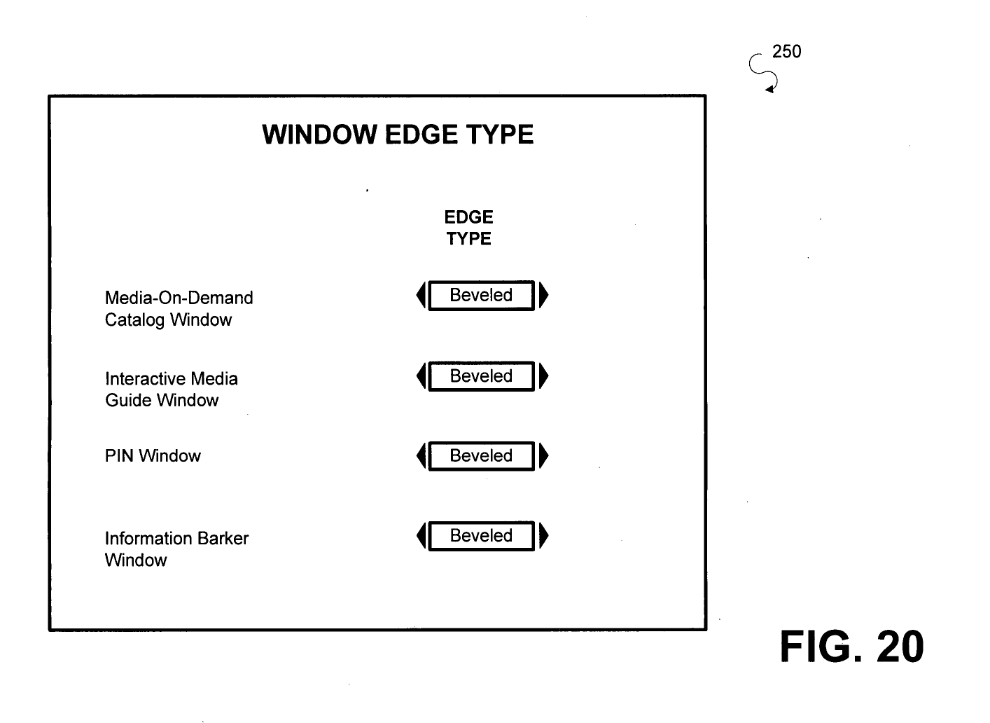

FIGS. 20, 21, 22, and 23 depict example edge configuration windows 250, 260, 270, and 280 respectively: window 250 is used for configuring the type of a window edge, window 260 is used for configuring the thickness of a window edge, window 270 is used for configuring the color of a window edge, and window 280 is used for configuring the continuity of a window edge. A user and/or system operator may determine configuration settings for various windows edges including a media title selection window edge 119, an interactive media guide window edge 139, a stopped video window edge 149, an information barker edge 159, and a PIN entry window edge 179.

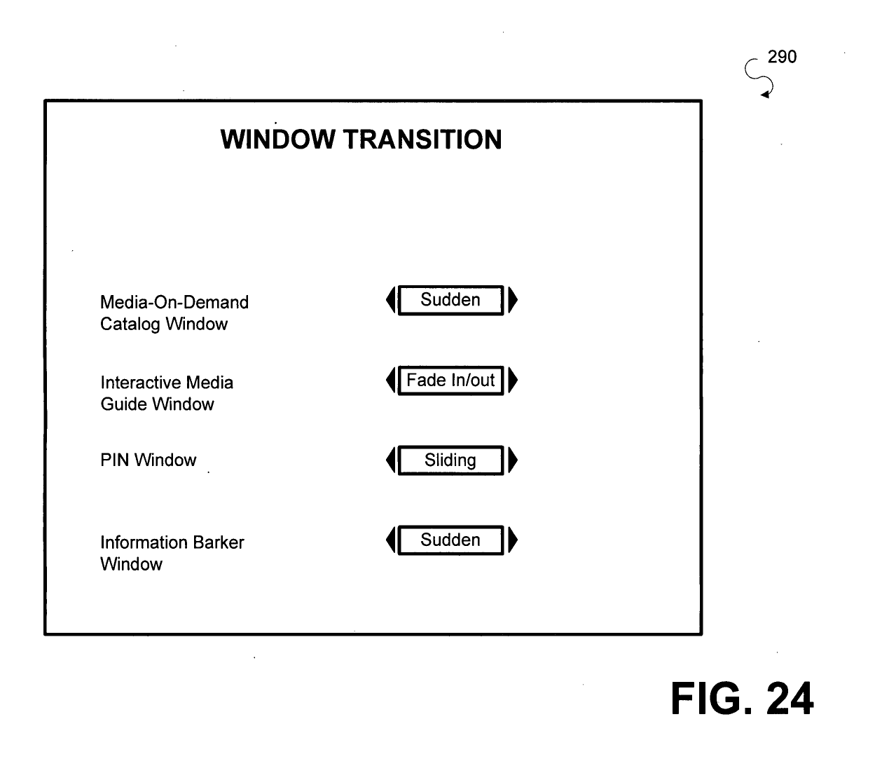

FIG. 24 depicts an example transition animation configuration window. Transition configuration settings determine the animation effects used to introduce new windows and include settings such as sudden transition, fade in/out transition, wipes, spiral fills, expansion from a small area to the window's final size over a period of time, and similar counterpart transitions for screen removals.

Other configurable visual settings may include the characteristics of a “highlighted field” or the texture of window. A highlighted field, for example, may be configured to blink, or to be darker/lighter than surrounding fields. The texture of a window may include characteristics such as a color or intensity gradient or a background pattern. The current invention is not limited to the above mentioned visual settings but includes all visual settings that are capable of being selected or determined by a user and/or system operator.

In one embodiment, a user and/or system operator may select a first visual settings scheme comprising a set of visual settings from a plurality of visual settings schemes. Hence, a user and/or system operator can select a predefined visual settings scheme without having to navigate through each respective visual settings feature configuration screen. In yet another embodiment, a user and/or system operator is allowed to modify individual visual settings features corresponding to a previously selected visual settings scheme. Upon a selection of a first visual settings scheme from a plurality of visual settings schemes, all subsequent DHCT generated windows are displayed in accordance with a first visual settings scheme until a user or system operator selects a second visual settings scheme from the plurality of selectable or configurable schemes.

The entries made and/or options selected by a user while being provided with windows 190-290 (FIGS. 14-24 respectively) are stored in a visual settings database 74. Client applications, such as the MOD client application 63 or the IMG application 72, access the visual settings database 74 in order to determine what visual settings to use when providing a user with a window or barker (for example, a window or barker as discussed above). In some embodiments, since various applications may be provided and designed by different companies, it is very useful to have similar visual qualities throughout the different applications. In one embodiment, applications access the visual settings database 74 every time that the DHCT 16 is turned on. In an alternative embodiment, applications access the visual settings database 74 at predetermined time intervals. In yet another embodiment, the visual settings are stored at the headend 11. The current invention is not limited by where the visual setting data is stored or when or how it is retrieved by an application.

It should be emphasized that the above-described embodiments of the present invention, particularly any “preferred embodiments”, are merely possible examples of the implementations, merely setting forth a clear understanding of the principles of the inventions. Many variations and modifications may be made to the above-described embodiments of the invention without departing substantially from the spirit of the principles of the invention. All such modifications and variations are intended to be included herein within the scope of the disclosure and present invention and protected by the following claims.

Therefore, having thus described the invention, the following is claimed:

1-24. (canceled)

25. A method implemented by a television set-top terminal (STT) configured to display television programs and a plurality of structured graphical presentations, each structured graphical presentation comprising a plurality of graphical elements, each graphical element associated with at least one visual attribute, the method comprising the steps of:
displaying a configuration window corresponding to a first visual attribute, the configuration window comprising a plurality of configurations, each configuration corresponding to one of the structured graphical presentations, each configuration defining a value for the first visual attribute of a first one of the graphical elements in the corresponding structured graphical presentation; and
configuring each structured graphical presentation for display in accordance with its corresponding configuration, such that the first visual attribute of the first one of the graphical elements in the structured graphical presentation is displayed in accordance with the value defined in the corresponding configuration.

26. The method of claim 25, wherein the first visual attribute of the first graphical element corresponds to a color.

27. The method of claim 25, wherein the first visual attribute of the first graphical element corresponds to a font type.

28. The method of claim 25, wherein the first visual attribute of the first graphical element corresponds to a font size.

29. The method of claim 25, wherein the first visual attribute of the first graphical element corresponds to an edge type.

30. The method of claim 25, wherein the first visual attribute of the first graphical element corresponds to a type of edge continuity.

31. The method of claim 25, wherein a first structured graphical presentation in the plurality of structured graphical presentations corresponds to a list of on-demand movies available via the STT, and a second structured graphical presentation in the plurality of structured graphical presentations corresponds to an electronic program guide available via the STT.

32. The method of claim 31, wherein a third structured graphical presentation in the plurality of structured graphical presentations corresponds to an information barker presenting information associated with an on-demand movie available via the STT.

33. The method of claim 25, wherein the step of displaying the configuration window is responsive to a user input corresponding to a request for a visual setting.

34. The method of claim 25, further comprising the step of receiving a first user input corresponding to a first value defining the first visual attribute of the first graphical element in a first structured graphical presentation, and receiving a second user input corresponding to a second value defining the first visual attribute of the first graphical element in a second structured graphical presentation.

35. The method of claim 34, wherein the first structured graphical presentation corresponds to a list of on-demand movies available via the STT, and the second structured graphical presentation corresponds to an electronic program guide available via the STT.

36. The method of claim 35, wherein the first visual attribute of the first graphical element corresponds to an edge type.

37. The method of claim 25, wherein a first structured graphical presentation corresponds to a large window presentation and a second structured graphical presentation corresponds to a window presentation smaller than the large window presentation.

38. The method of claim 37, further comprising the step of receiving a first user input corresponding to a first value defining the first visual attribute of the first graphical element in the first structured graphical presentation, and receiving a second user input corresponding to a second value defining the first visual attribute of the first graphical element in the second structured graphical presentation.

39. The method of claim 38, further comprising the step of outputting by the STT information corresponding to on-demand movies in a first instance of the first structured graphical presentation, and outputting by the STT information corresponding to an electronic program guide in a second instance of the first structured graphical presentation, said first and second instances of the first structured graphical presentation including the first graphical element according to the first value defining the first visual attribute.

40. The method of claim 39, further comprising the step of outputting by the STT an information barker in a first instance of the second structured graphical presentation, the first instance of the second structured graphical presentation including the first graphical element according to the second value defining the first visual attribute.

41. A method implemented by a television set-top terminal (STT) configured to display television programs and a plurality of structured graphical presentations, each structured graphical presentation comprising a plurality of graphical elements, each graphical element having at least one visual attribute, the method comprising the steps of:
displaying a configuration window corresponding to a first visual attribute, the configuration window comprising a plurality of configurations, each configuration corresponding to one of the structured graphical presentations, each configuration defining a value for the first visual attribute of a first one of the graphical elements in the corresponding structured graphical presentation; and
displaying a first and a second structured graphical presentation in the plurality of structured graphical presentations, in accordance with a corresponding configuration, such that the first visual attribute of the first one of the graphical elements in the structured graphical presentation is displayed in accordance with the value defined in the corresponding configuration,
wherein the first structured graphical presentation corresponds to a large window presentation and the second structured graphical presentation corresponds to a window presentation smaller than the large window presentation.

42. The method of claim 41, further comprising the step of receiving a first user input corresponding to a first value defining the first visual attribute of the first graphical element in the first structured graphical presentation, and a second user input corresponding to a second value defining the first visual attribute of the first graphical element in the second structured graphical presentation.

43. The method of claim 41, further comprising the step of outputting by the STT information corresponding to on-demand movies in a first instance of the first structured graphical presentation, and outputting by the STT information corresponding to an electronic program guide in a second instance of the first structured graphical presentation, said first and second instances of the first structured graphical presentation including the first graphical element according to the first value defining the first visual attribute.

44. The method of claim 43, further comprising the step of outputting by the STT an information barker in a first instance of the second structured graphical presentation, said first instance of the second structured graphical presentation including the first graphical element according to the second value defining the first visual attribute.

45. A method implemented by a television set-top terminal (STT) configured to display television programs and a plurality of structured graphical presentations, each structured graphical presentation comprising a plurality of graphical elements, each graphical element associated with at least one visual attribute, the method comprising the steps of:
displaying a configuration window corresponding to a first visual attribute, the configuration window comprising a plurality of configurations, each configuration corresponding to one of the structured graphical presentations, each configuration defining a value for the first visual attribute of a first one of the graphical elements in the corresponding structured graphical presentation; and
configuring each structured graphical presentation for display in accordance with its corresponding configuration, such that the first visual attribute of the first one of the graphical elements in the structured graphical presentation is displayed in accordance with the value defined in the corresponding configuration,
wherein a first structured graphical presentation in the plurality of structured graphical presentations corresponds to a presentation of media on-demand information and a second structured graphical presentation in the plurality of structured graphical presentations corresponds to a presentation of television program information.

46. The method of claim 45, further comprising the step of receiving a first user input corresponding to a first value defining the first visual attribute of the first graphical element in the first structured graphical presentation, and a second user input corresponding to a second value defining the first visual attribute of the first graphical element in the second structured graphical presentation.

47. The method of claim 45, further comprising the step of outputting by the STT media on-demand information in the first structured graphical presentation in the first structured graphical presentation, said first structured graphical presentation including the first graphical element according to the first value defining the first visual attribute.

48. The method of claim 46, further comprising the step of outputting by the STT television program information in the second structured graphical presentation in the first structured graphical presentation, said second structured graphical presentation including the first graphical element according to the second value defining the first visual attribute.

49. The method of claim 45, wherein the first visual attribute of the first graphical element corresponds to an edge type.

50. A method implemented by a television set-top terminal (STT) configured to display television programs and a plurality of structured graphical presentations, each structured graphical presentation comprising a plurality of graphical elements, each graphical element associated with at least one visual attribute, the method comprising the steps of:
displaying a configuration window corresponding to a first visual attribute, the configuration window comprising a plurality of user-configurable options, each user-configurable option corresponding to one of the plurality of structured graphical presentations, each option defining the first visual attribute of a first one of the graphical elements in the corresponding structured graphical presentation;
receiving a value from a user corresponding to the user-configurable option for at least one of the structured graphical presentations; and
providing television-related information in a displayed instance of the at least one structured graphical presentation, said displayed instance of the at least one structured graphical presentation including the first graphical element according to the value received from the user.

51. A method implemented by a television set-top terminal (STT) configured to display television programs and a plurality of structured graphical presentations, each structured graphical presentation comprising a plurality of graphical elements, the method comprising the steps of:
displaying a configuration window comprising exclusively a plurality of user-configurable options, each user-configurable option associated with a first graphical element in a corresponding one of the plurality of structured graphical presentations;
receiving a first user input corresponding to the user-configurable option for at least one of the structured graphical presentations; and
providing television-related information in a displayed instance of the at least one structured graphical presentation, said displayed instance of the at least one structured graphical presentation including the first graphical element according to the first user input.

52. A method implemented by a television set-top terminal (STT) configured to display television programs and a plurality of structured graphical presentations, each structured graphical presentation comprising a plurality of graphical elements, each graphical element having at least one visual attribute, the method comprising the step of:
providing for display a plurality of configuration windows for a plurality of visual attributes, each configuration window corresponding exclusively to a respective visual attribute of a first one of the graphical elements, each configuration window comprising a plurality of respective configurable options corresponding to one of the structured graphical presentations, each respective configurable option in a configuration window defining the value of the visual attribute of the first graphical element in the corresponding structured graphical presentation.
